(19) United States
(12) Patent Application Publication
(10) Pub. No.: US 2017/0185456 A1
(43) Pub. Date: Jun. 29, 2017

(54) DYNAMICALLY SCALED WEB SERVICE DEPLOYMENTS

(71) Applicant: LONGSAND LIMITED, Cambridge (GB)

(72) Inventors: Julien Bramary, Bristol (GB); Irfan Habib, Bristol (GB); David Banks, Bristol (GB)

(21) Appl. No.: 15/304,925

(22) PCT Filed: May 1, 2014
(86) PCT No.: PCT/EP2014/058958

§ 371 Date: Oct. 18, 2016

(51) Int. Cl. G06F 9/50; G06Q 10/06

(52) U.S. Cl. CPC G06F 9/5061; G06Q 10/063118

(57) ABSTRACT

In an example, web service deployments may be scaled dynamically by monitoring service level metrics relating to a worker and a job queue. Based on the monitored service level metrics, values are calculated for an average worker capacity, a number of workers required to process the incoming jobs, and a number of workers required to process queued jobs. A target number of workers to process the incoming and the queued jobs is then determined at a particular point in time based on the calculated values. Accordingly, the number of workers is adjusted to match the determined target number of workers by provisioning new workers or terminating active workers as required.

### BACKGROUND

With the advent of cloud computing, a cloud computing system may programmatically create or terminate computing resources provided by virtual machines to adapt to fluctuations in a workload. These computing resources may incorporate all facets of computing from raw processing power to bandwidth to massive storage space. Generally, a human operator manually scales the computing resources so that adequate resources are allocated at each point in time to meet a current workload demand without disrupting the operations of the cloud computing system.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a job queue architecture to dynamically scale web service deployments, according to an example of the present disclosure;

FIG. 2 shows a block diagram of a computing device to dynamically scale web service deployments, according to an example of the present disclosure;

FIG. 3 shows a flow diagram of a method to dynamically scale web service deployments, according to an example of the present disclosure;

FIG. 4 shows a flow diagram of a peak tracking method to regulate an excessive termination of workers by utilizing an average rate of incoming job values, according to an example of the present disclosure; and

FIG. 5 shows a flow diagram of a dynamic termination deadband method to regulate an excessive creation or termination of workers, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

Disclosed herein are examples of a method to automatically and dynamically scale web service deployments based on aggregated service level metrics. A web service, for instance, is a software system designed to support interoperable machine-to-machine interaction over a network. The disclosed method scales a capacity of a web service deployment to meet variations in demand without requiring human intervention. In this regard, the disclosed method may provision an optimal number of web servers to match a current workload in a cost effective manner. Also disclosed herein is a computing device for implementing the methods and a non-transitory computer readable medium on which is stored machine readable instructions that implement the methods.

According to a disclosed example, web service deployments may be scaled dynamically by monitoring service level metrics relating to a pool of workers and a job queue. The service level metrics, for instance, may include an average time it takes for each worker to process a job, a maximum number of jobs the worker can process in parallel, a depth of a job queue, and a rate of incoming jobs to the job queue. A scaling algorithm may be implemented to determine a target number of workers to process the incoming and the queued jobs based on the monitored service level metrics. That is, values may be calculated for an average worker capacity, a number of workers required to process the incoming jobs, and a number of workers required to process queued jobs. Based on the calculated values, the target number of workers to process the incoming and the queued jobs may then be determined at a particular point in time. Accordingly, a number of active workers may be adjusted to match the determined target number of workers.

According to another example, exceptionally noisy and cyclic job loads may be mitigated by regulating the excessive creation or termination of workers. For instance, the excessive creation or termination of workers may be regulated by utilizing an average rate of incoming jobs values instead of an instant rate of incoming job values, preventing worker termination in the presence of a significant backlog of the job queue, and/or utilizing a dynamic termination deadband as a dampening agent.

The disclosed examples provide an open loop method to dynamically scale web service deployments that is inherently stable for an applied workload. The open loop method, for instance, is concerned with a current workload and is not concerned with predicting future workloads. The disclosed examples directly measure the applied load (e.g., the number of service requests per second) and continuously monitor the capacity of all workers. Based on the applied load and the average capacity of a worker, the number of workers needed to process the incoming and the queued jobs are predicted for a current point in time. Accordingly, the disclosed examples may mitigate a long provisioning time of a new worker (e.g., minutes) by deliberately over-provisioning workers to ensure that any backlog of queued jobs is addressed within a predetermined burn duration, which is designated to clear the job queue.

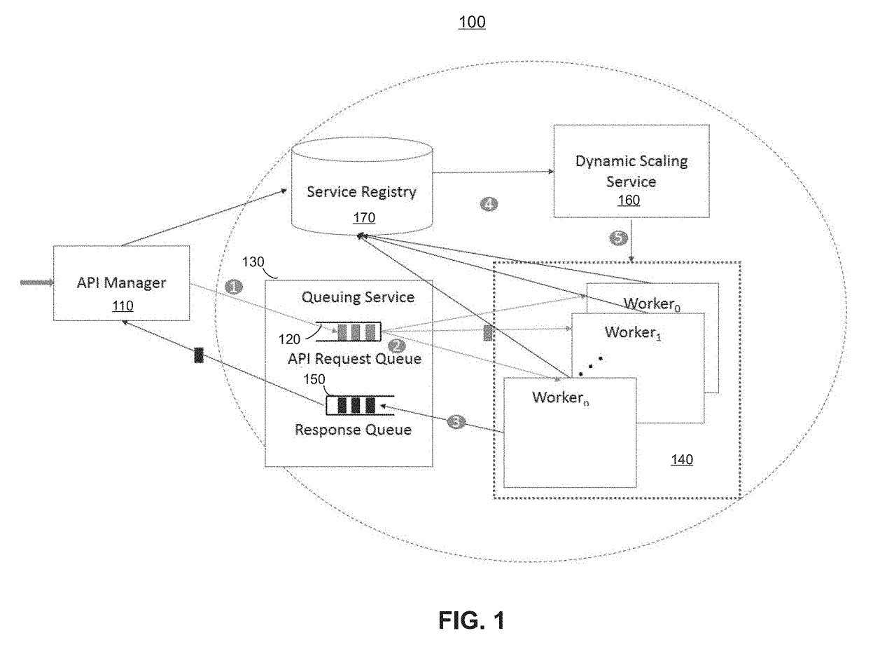

With reference to FIG. 1, there is shown a block diagram of a job queue architecture 100 to dynamically scale web service deployments according to an example of the present disclosure. It should be understood that the job queue architecture 100 may include additional components and that one or more of the components described herein may be removed and/or modified without departing from a scope of the job queue architecture 100.

Referring to FIG. 1, an application programming interface (API) manager 110 is a gateway through which service requests are received and responses are returned to a client application. An API may specify how software components should interact with each other. In other words, the API may be a representational state transfer (REST) end point that provides a specific predefined function.

According to an example, upon receiving a hypertext transfer protocol (HTTP) service request, the API manager 110 constructs a job and publishes it to a job queue 120 of a queuing service 130, as shown by arrow 1. A job, for instance, is a unit of work or a particular task that is to be processed. The job queue 120, for example, is a first-in-first-out job container and may be populated by the API manager 110. The queuing service 130, for example, is implemented by a RabbitMQ™ messaging system.

A worker, such as one of a plurality of workers 140, may remove a job from the job queue 120 as shown by arrows 2, process the job, and place a processed response into a response queue 150 as shown in arrow 3. The worker, for instance, is a service connected to the job queue 120 and the response queue 150 that is capable of processing jobs and formulating processed responses. The response queue 150 may be a first-and-first-out response container that is shared for all APIs and may be populated by the plurality of workers 140. According to an example, the API manager 110 removes the processed response from the response queue 150 and forwards the processed response to the client application that submitted the HTTP service request.

According to an example, a dynamic scaling service (DSS) 160 is a service that is responsible for aggregating service level metrics, such as job queue metrics received from the queuing service 130 and worker metrics received from a service registry 170, and making scaling decisions accordingly. For instance, the worker metrics may include, but are not limited to, the average time it takes for a worker to process a job (T_job) and the maximum number of jobs a worker can process in parallel (num_threads). These worker metrics may be used to calculate an average worker capacity (K_jps), which is a measure of how many jobs a worker can handle every second. The job queue metrics may include, but are not limited to, the rate of the incoming jobs per second (incoming_jps) and the backlog depth of the job queue 120 (queue_size) for the current HTTP service request.

That is, for each worker type, the DSS 160 may periodically monitor and aggregate the service level metrics as shown by arrows 4, implement a scaling algorithm to calculate a desired or target number of workers (new_target) to process the incoming and queued jobs based on the service level metrics, and create or terminate a number of active or current workers to match the determined target number of workers (new_target) as shown by arrow 5. The periodic time interval at which these actions are implemented by the DSS 160 is referred to as a DSS iteration period. The DSS iteration period may be predefined by a user and the designated period may be as frequent as every ten seconds according to an example.

The service registry 170, for example, is the primary metadata repository for the job queue architecture 100. The service registry 170 may connect all components of the job queue architecture 100 and store worker metrics, job queue parameters, configuration parameters, and the like. According to an example, each of the plurality of workers 140 periodically (e.g., every five minutes) publishes their average time to process a job (T_job) to the service registry 170. Specifically, each of the plurality of workers periodically publishes the weighted moving average of all the jobs that are processed and this worker performance metric is used in the scaling algorithm to calculate the average worker capacity. The average worker capacity, for example, may also be used to identify underperforming workers.

According to an example, once the target number of workers (new_target) has been calculated the scaling algorithm, the DSS 160 may query the service registry 170 to determine the number of active workers. The DSS 160 may then provision additional workers or terminate active workers to meet the desired target number of workers (new_target). This information may then be fed back into the scaling algorithm to determine a dynamic termination deadband as further discussed below. According to an example, Apache ZooKeeper™ may be leveraged to implement the service registry 170.

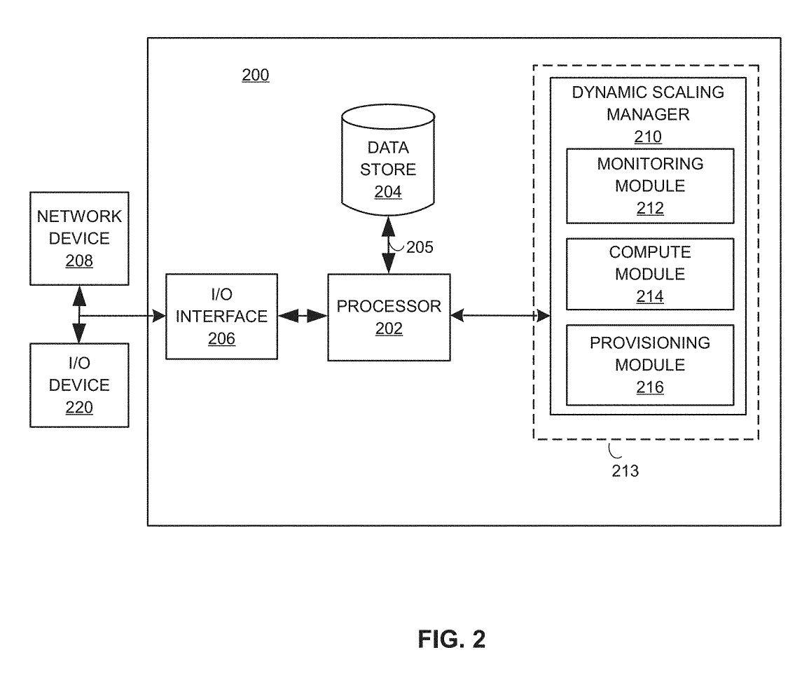

With reference to FIG. 2, there is shown a block diagram of a computing device 200 to dynamically scale web service deployments according to an example of the present disclosure. For instance, the computing device may execute the DSS 160 described above. It should be understood that the computing device 200 may include additional components and that one or more of the components described herein may be removed and/or modified without departing from a scope of the computing device 200.

The computing device 200 is depicted as including a processor 202, a data store 204, an input/output (I/O) interface 206, and a dynamic scaling manager 210. For example, the computing device 200 may be a desktop computer, a laptop computer, a smartphone, a computing tablet, or any type of computing device. Also, the components of the computing device 200 are shown on a single computer as an example and in other examples the components may exist on multiple computers. The computing device 200 may store or manage the service level metrics in a separate computing device, for instance, through a network device 208, which may include, for instance, a router, a switch, a hub, and the like. The data store 204 may include physical memory such as a hard drive, an optical drive, a flash drive, an array of drives, or any combinations thereof, and may include volatile and/or non-volatile data storage.

The dynamic scaling manager 210 is depicted as including a monitoring module 212, a compute module 214, and a provisioning module 216. The processor 202, which may be a microprocessor, a micro-controller, an application specific integrated circuit (ASIC), or the like, is to perform various processing functions in the computing device 200. The processing functions may include the functions of the modules 212-216 of the dynamic scaling manager 210. According to an example, the dynamic scaling manager 210 automatically and dynamically scales web service deployments in response to received service level metrics to ensure effective performance of the web service under load while lowering its operational cost when possible.

The monitoring module 212, for example, periodically monitors and aggregates service level metrics that are received from the queuing service 130 and the service registry 170. That is, the monitoring module may monitor metrics including the performance of a worker of the plurality of workers 140 (e.g., T_job and num_threads) received from the service registry 170 and job queue metrics (e.g., queue_size, incoming_jps) received from the queuing service 130. According to an example, the monitoring module 212 may generate an average rate of incoming jobs by calculating a maximum of a quick average and a slow average to regulate excessive worker termination under noisy or cyclic job loads. The quick average may be an age-weighted average with a sample maximum age of a monitoring iteration period and the slow average may be an age-weighted average with a sample maximum age that is at least longer than the quick average.

The compute module 214, for example, run a scaling algorithm based on the received service level metrics to determine a target number of workers (new_target) to process all incoming and queued jobs at a particular point in time. Particularly, the compute module 214 may calculate values for an average worker capacity (K_jps), a number of workers required to process the incoming jobs (ideal_target), and a number of workers required to process queued jobs (backlog_target) based on the service level metrics. Based on these calculated values, the compute module 214 may determine a target number of workers (new_target) to process the incoming and queued jobs at a particular point in time.

The provisioning module 216, for example, may provision or terminate a number of active workers to match the determined target number of workers (new_target). According to an example, the provisioning module 216 only terminates the number of active workers to match the determined target number of workers (new_target) if a terminate flag is set to true as further discussed below. According to another example, the provisioning module 216 only terminates the number of active workers that exceed a dynamic termination deadband value. The provisioning module 216 may keep track of the worker provisioning and termination events and feed this information back into the scaling algorithm to determine the dynamic termination deadband as further discussed below.

In an example, the dynamic scaling manager 210 includes machine readable instructions stored on a non-transitory computer readable medium 213 and executed by the processor 202. Examples of the non-transitory computer readable medium include dynamic random access memory (DRAM), electrically erasable programmable read-only memory (EEPROM), magnetoresistive random access memory (MRAM), memristor, flash memory, hard drive, and the like. The computer readable medium 213 may be included in the data store 204 or may be a separate storage device. In another example, the dynamic scaling manager 210 includes a hardware device, such as a circuit or multiple circuits arranged on a board. In this example, the modules 212-216 are circuit components or individual circuits, such as an embedded system, an ASIC, or a field-programmable gate array (FPGA).

The processor 202 may be coupled to the data store 204 and the I/O interface 206 by a bus 205 where the bus 205 may be a communication system that transfers data between various components of the computing device 200. In examples, the bus 105 may be a Peripheral Component Interconnect (PCI), Industry Standard Architecture (ISA), PCI-Express, HyperTransport®, NuBus, a proprietary bus, and the like.

The I/O interface 206 includes a hardware and/or a software interface. The I/O interface 206 may be a network interface connected to a network through the network device 208, over which the dynamic scaling manager 210 may receive and communicate information. For example, the input/output interface 206 may be a wireless local area network (WLAN) or a network interface controller (NIC). The WLAN may link the computing device 200 to the network device 208 through a radio signal. Similarly, the NIC may link the computing device 200 to the network device 208 through a physical connection, such as a cable. The computing device 200 may also link to the network device 208 through a wireless wide area network (WWAN), which uses a mobile data signal to communicate with mobile phone towers. The processor 202 may store information received through the input/output interface 206 in the data store 204 and may use the information in implementing the modules 212-216.

The I/O interface 206 may be a device interface to connect the computing device 200 to one or more I/O devices 220. The I/O devices 220 include, for example, a display, a keyboard, a mouse, and a pointing device, wherein the pointing device may include a touchpad or a touchscreen. The I/O devices 220 may be built-in components of the computing device 200, or located externally to the computing device 200. The display may be a display screen of a computer monitor, a smartphone, a computing tablet, a television, or a projector.

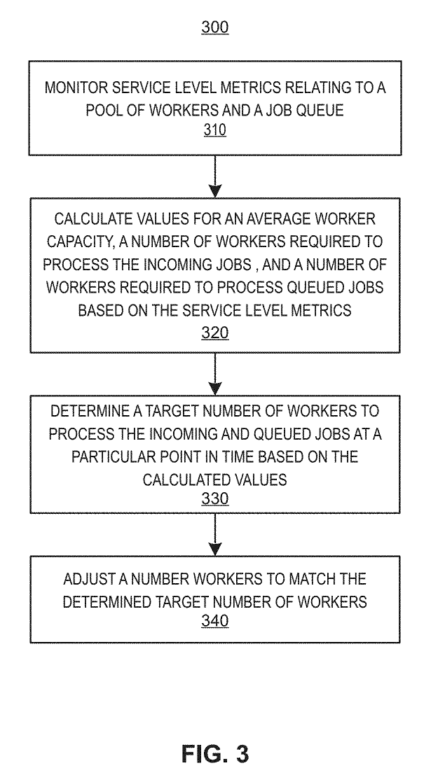

With reference to FIG. 3, there is shown a flow diagram of a method 300 to dynamically scale web service deployments, according to an example of the present disclosure. The method 300 is implemented, for example, by the processor 202 of computing device 200 as depicted in FIG. 2.

In block 310, the monitoring module 212, for example, may monitor service level metrics relating to a worker from the plurality of workers 140 and the job queue 120. The monitored service level metrics may include, but are not limited to, an average time it takes for the worker to process each job (T_job), a maximum number of jobs the worker can process in parallel (num_threads), a depth of a job queue 120 (queue_size), and a rate of incoming jobs to the job queue 120 per second (incoming_jps). According to an embodiment, the T_job and num_threads metrics may be obtained from the service registry 170 and the queue_size and incoming_jps metrics may be obtained from the queuing service 130.

As shown in blocks 320 and 330, the compute module 214, for example, may implement a scaling algorithm to ensure that a sufficient worker capacity is available in order to keep the job queue 120 shallow. That is, the scaling algorithm may be implemented to cope with the rate of incoming jobs to the job queue 120 (incoming_jps), ensure that no job queue backlog accumulates over time and remove any existing job backlog (i.e., queued jobs) within a reasonable amount of time. The implementation of the scaling algorithm also ensures that each worker of the plurality of workers 140 is close to load saturation for cost-efficiency.

As shown in block 320, the compute module 214 may calculate values for an average worker capacity (K_jps), a number of workers required to process the incoming jobs (ideal_target), and a number of workers required to process queued jobs (backlog_target) based on the service level metrics. According to an example, the average worker capacity (K_jps) is calculated by dividing a maximum number of jobs the worker can process in parallel (num_threads) by the average time it takes for the worker to process each job (T_job) as follows:

K_jps=num_threads/T_job.

Using the average worker capacity (K_jps) value along with the rate of the incoming jobs per second metric (incoming_jps), the compute module 214 may calculate the number of workers required to process the incoming jobs (ideal_target) as follows:

ideal_target=incoming_jps/K_jps.

Next, the compute module 214 may calculate the number of workers required to process the queued jobs in an amount of burn time (burn_duration) configured in the service registry 270. First, the compute module 214 may normalize the queue backlog (queue_size) to determine how many seconds it takes one worker to burn the queued jobs (backlog_sec) as follows:

backlog_sec=queue_size/K_jps.

The compute module 214 may then calculate the number of workers required to process the queued jobs (backlog_target) by dividing the burn time (backlog_sec) by a burn duration (burn_duration), which is a predetermined amount of time that a user is prepared to wait for the backlogged queue to clear, as follows:

backlog_target=backlog_sec/burn_duration.

In block 330, the compute module 214, for example, may determine a target number of workers (new_target) to process the incoming and queued jobs at a particular point in time based on the calculated values. For example, the compute module 214 may add the number of workers required to process the incoming jobs (ideal_target) to the number of workers required to process queued jobs (backlog_target) and round up to compute a target value. This target value would be ideal at the instant of the scaling iteration. However, worker provisioning delays can lead to a job queue backlog and not all workers may be able to always run at capacity due to various workloads. To compensate for this, the target value is multiplied by a predetermined scaling factor that is configured in the service registry 170 to calculate the target number of workers to process the incoming and queued jobs, as follows:

new_target=1.1*(ideal_target+backlog_target),

new_target=(1.1/K_jps)*(incoming_jps+queue_size/burn_duration),

or

new_target=(1.1*T_job/num_threads)*(incoming_jps+queue_size/burn_duration), where 1 is the scaling factor.

The scaling factor of this example is set to 1.1 by a user to provision a 10% overhead to cope with unforeseen circumstances. The scaling factor value may be configurable by a user. For instance, a scaling factor of 1.0 is the exact amount of workers needed to process the incoming and queued jobs.

In block 340, the provisioning module 216, for example, may adjust a number of active workers to match the determined target number of workers (new_target). The method 300 discussed above may be implemented periodically at each DSS iteration period. The DSS iteration period may be predefined by a user and the designated period may be as frequent as every ten seconds according to an example.

According to an example, the method 300 may mitigate exceptionally noisy and cyclic job loads by regulating the excessive creation or termination of workers. The method 300 may regulate the excessive creation or termination of workers by utilizing a combination of averaged or low-pass filtered incoming_jps values instead of the instant incoming_jps value, preventing worker termination in the presence of a significant backlog of the job queue 120, and/or utilizing a dynamic termination deadband as discussed further below.

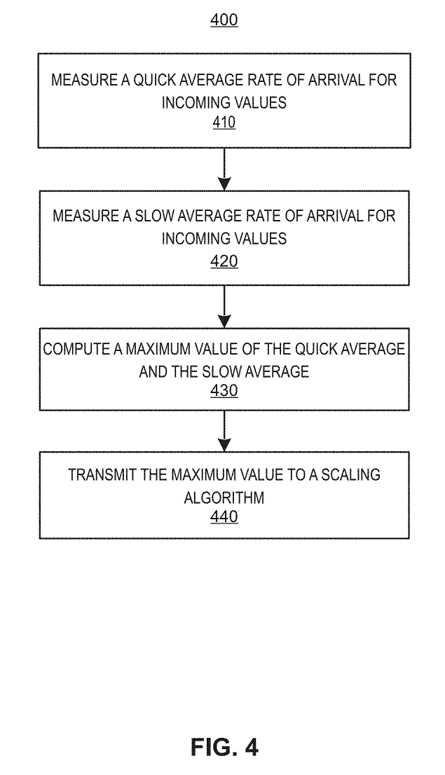

With reference to FIG. 4, there is shown a flow diagram of a peak tracking method 400 to regulate excessive termination of workers by utilizing an average rate of incoming job values (incoming_jps), according to an example of the present disclosure. The peak tracking method 400 is implemented, for example, by the processor 202 of computing device 200 as depicted in FIG. 2.

According to an example, the average rate of the incoming values (incoming_jps) may be monitored over time and fed into the DSS 160 to be implemented in the scaling algorithm discussed in blocks 320 and 330 of FIG. 3. In this regard, the scaling algorithm may still react quickly to sudden increases in load, but may take longer to react to sudden decreases in load to cope with future fast-changing or noisy job load patterns.

In particular, a quick average rate of arrival is measured for incoming values (incoming_jps) as shown in block 410. The quick average, for example, may be an age-weighted average with a sample maximum age of a DSS iteration period, such as the age-weighted average rate of the incoming values (incoming_jps) during the past 10 seconds. In block 420, the slow average rate of arrival is measured for the incoming values (incoming_jps). The slow average, for example, may be an age-weighted average with a sample maximum age that is at least longer than the quick average, such as the age-weighted average rate of the incoming values (incoming_jps) during the past 20 minutes. In block 430, a maximum value of the quick average and the slow average is calculated. The maximum value may then be transmitted to the DSS 160 to be implemented in the scaling algorithm as shown in block 440 to regulate the excessive termination of workers and cope with future fast-changing or noisy job load patterns.

According to another example, the excessive termination of workers may be regulated by a burning regime that prevents worker termination in the presence of a significant backlog of the job queue 120. For instance, the number of active workers may be terminated to match the determined target number of workers (new_target) only if a terminate flag is set to true. The terminate flag, for example, may be set to true if the amount of time it takes the pool of workers to burn the queued jobs (backlog_sec) does not surpass a predetermined lower threshold set by a user (e.g., 12 seconds). If the backlog_sec value surpasses a predetermined higher threshold (e.g., 120 seconds), however, the terminate flag is set to false and the number of active workers are not terminated. This use of two thresholds gives some hysteresis that prevents the terminate flag unnecessarily oscillating between states. Thus, the burning regime may prevent the excessive termination of active workers to cope with future fast-changing or noisy job load patterns.

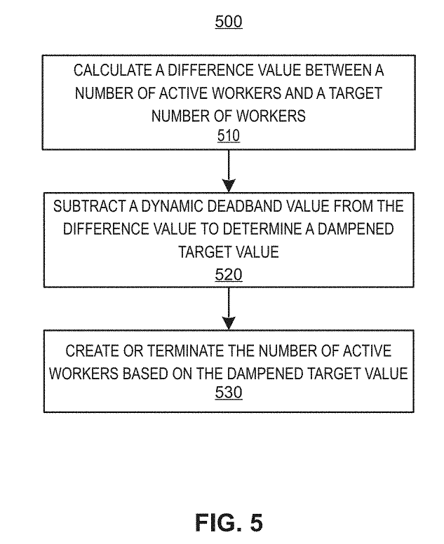

Referring to FIG. 5, there is shown a flow diagram of a dynamic termination deadband method 500 to regulate the excessive creation or termination of workers, according to another example. The dynamic termination deadband method 500 is implemented, for example, by the processor 202 of computing device 200 as depicted in FIG. 2.

The dynamic termination deadband may act as a dampening agent in the scaling algorithm. That is, the termination deadband may be computed dynamically at every DSS iteration as a function of how many workers were created and terminated during a recent period of time (e.g., during the hour preceding the latest DSS iteration). The primary function of the termination deadband is to restrict the number workers that may be terminated during times of noisy or cyclical job load patterns, in order to better meet future demand. In the dynamic termination deadband method 500, all worker creation and termination events may be time-stamped and stored for at least a max_event_age (e.g., 1 hour). At a particular point in time t, all stored creation and termination events can be given a weight that is inversely proportional to their age. An event that would coincide with time t would have a weight of 1.0. An event older than max_event_age has a weight of 0.0 and can be discarded. At time t, the termination dead band is calculated as the sum of the weights of all creation and termination events rounded down to the nearest integer, plus a predetermined minimum deadband (e.g., 1). For example, at time t where:

minimum_deadband=1,

max_event_age=60 minutes,

3 creation events at t minus 30 minutes: weight of 0.5, and

1 termination event at t minus 15 minutes: weight 0.75, the termination deadband may be determined as follows:

termination deadband=1+floor(3*0.5+1*0.75),

termination deadband=1+2,

termination deadband=3.

As shown in block 510, the provisioning module 216, for instance, may calculate a difference value between the number of active workers and the target number of workers (new_target). The provisioning module 216 may subtract a dynamic deadband value from the difference value to determine a dampened target value, as shown in block 520. Accordingly, the provisioning module 216 may then create or terminate the number of active workers based on the dampened target value, as shown in block 530. For example, a termination deadband value of 3 indicates that if there are currently 8 active workers and the target number of workers (new_target) is 4, the provisioning module 216 would only terminate 1 worker instead of 4 to cope with future fast-changing or noisy job load patterns.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method to dynamically scale web service deployments, comprising:
monitoring, by a processor, service level metrics relating to a pool of workers and a job queue;
calculating values for an average worker capacity, a number of workers required to process the incoming jobs, and a number of workers required to process queued jobs based on the service level metrics;
determining a target number of workers to process the incoming and the queued jobs at a particular point in time based on the calculated values; and
adjusting a number of active workers to match the determined target number of workers.

2. The method of claim 1, wherein the service level metrics include an average time it takes for a worker from the pool of workers to process each job, a maximum number of jobs the worker can process in parallel, a depth of a job queue, and a rate of incoming jobs to the job queue.

3. The method of claim 2, wherein the calculating of the values for the average worker capacity includes dividing a maximum number of jobs the worker can process in parallel by the average time it takes for the worker to process each job.

4. The method of claim 3, wherein the calculating of the number of workers required to process the incoming jobs includes dividing the rate of the incoming jobs by the average worker capacity.

5. The method of claim 3, wherein the calculating of the number of workers required to process the queued jobs includes:
determining a burn time required for the worker to process the queued jobs, wherein the burn time is calculated by dividing the depth of the job queue by the average worker capacity; and
determining the number of workers required to process the queued jobs by dividing the burn time by a predetermined burn duration, wherein the burn duration is a designated amount of time to clear the job queue.

6. The method of claim, wherein the determining of the target number of workers to process the incoming and queued jobs includes:
adding the number of workers required to process the incoming jobs to the number of workers required to process queued jobs to compute a target value; and
multiplying the target value by a predetermined scaling factor to calculate the target number of workers to process the incoming and queued jobs.

7. The method of claim 2, wherein the monitoring of the rate of incoming jobs includes:
generating an average rate of incoming jobs by calculating a maximum of a quick average and a slow average,
wherein the quick average is an age-weighted average with a sample maximum age of a monitoring iteration period and the slow average is an age-weighted average with a sample maximum age that is at least longer than the quick average.

8. The method of claim 1, wherein the adjusting of the number of active workers includes terminating the number of active workers to match the determined target number of workers only if a terminate flag is set to true.

9. The method of claim 1, wherein the adjusting of the number of active workers includes:
calculating a difference value between the number of active workers and the determined target number of workers;
subtracting a dynamic deadband value from the difference value to determine a dampened target value; and
creating or terminating the number of active workers based on the dampened target value.

10. A computing device to dynamically scale web service deployments, comprising:
a processor;
a memory storing machine readable instructions that are to cause the processor to:
aggregate metrics received from a plurality of workers and a job queue, wherein the metrics include an average time it takes for a worker from the plurality of workers to process each job, a maximum number of jobs the worker can process in parallel, a depth of a job queue, and a rate of incoming jobs to the job queue;
implement a scaling algorithm using the aggregated metrics, wherein the scaling algorithm is implemented to:
compute values for a number of workers required to process the incoming jobs and total number of workers required to process queued jobs, and
determine a target number of workers to process the incoming and the queued jobs at a particular point in time based on the computed values; and
provision new workers or terminate active workers according to the determined target number of workers.

11. The computing device of claim 10, wherein to compute the number of workers required to process the incoming jobs, the machine readable instructions are further to cause the processor to divide the rate of the incoming jobs by an average worker capacity.

12. The computing device of claim 11, wherein to compute the number of workers required to process the queued jobs, the machine readable instructions are further to cause the processor to:
determine a burn time required for the worker to process the queued jobs, wherein the burn time is calculated by dividing the depth of the job queue by the average worker capacity; and
determine the number of workers required to process the queued jobs by dividing the burn time by a predetermined burn duration, wherein the burn duration is a designated amount of time to clear the job queue.

13. The computing device of claim 10, wherein to determine the target number of workers to process the incoming and queued jobs, the machine readable instructions are further to cause the processor to:
add the number of workers required to process the incoming jobs to the number of workers required to process queued jobs to compute a target value; and
multiply the target value by a predetermined scaling factor to calculate the target number of workers to process the incoming and queued jobs.

14. A non-transitory computer readable medium to dynamically scale web service deployments, including machine readable instructions executable by a processor to:
aggregate, using a monitoring module, service level metrics for a pool of workers received from a metadata repository and service level metrics for queued jobs received from a job queue;
calculate, using a compute module, values for a number of workers required to process the incoming jobs and a number of workers required to process the queued jobs based on the service level metrics to determine a total number of workers to process the incoming and the queued jobs at a particular point in time;
adjust, using a provisioning module, a number of active workers to match the determined target number of workers; and
regulate, using the provisioning module, worker termination if a processing time for the queued jobs surpasses a predetermined threshold.

15. The non-transitory computer readable medium of claim 14, wherein to determine the total number of workers to process the incoming and the queued jobs, the machine readable instructions are executable by the processor to:
add the number of workers required to process the incoming jobs to the number of workers required to process queued jobs to compute a target value; and
multiply the target value by a predetermined scaling factor to calculate the total number of workers to process the incoming and queued jobs.
